(19) United States
(12) Patent Application Publication
(10) Pub. No.: US 2025/0308808 A1
(43) Pub. Date: Oct. 2, 2025

(54) COMPOSITE POWDER FOR USE IN MANUFACTURING POROUS BODY CONTAINED IN ANODE BODY OF ELECTROLYTIC CAPACITOR, MANUFACTURING METHOD OF SAID COMPOSITE POWDER, AND MANUFACTURING METHOD OF ANODE BODY FOR ELECTROLYTIC CAPACITOR

(71) Applicant: Panasonic Intellectual Property Management Co., Ltd., Osaka (JP)

(72) Inventors: Masayuki HOGIRI, OSAKA FU (JP); Yukiyasu SUGIHARA, AICHI KEN (JP); Takeshi NOMURA, OSAKA FU (JP)

(21) Appl. No.: 19/088,364

(22) Filed: Mar. 24, 2025

(30) Foreign Application Priority Data
Mar. 28, 2024 (JP) 2024-053954

(51) Int. Cl. H01G 9/052; H01G 9/028; H01G 9/15

(52) U.S. Cl. CPC H01G 9/0525; H01G 9/028; H01G 9/15

(57) ABSTRACT

The present invention aims to enhance the reliability of a porous body contained in an anode body of an electrolytic capacitor. A composite powder for use in manufacturing a porous body contained in an anode body of an electrolytic capacitor includes a raw material powder containing a valve metal, and an aromatic compound (excluding naphthalene and a polymer) adhered to surfaces of particles of the raw material powder. The aromatic compound has a melting point of 35° C. or more and 120° C. or less.

### CROSS REFERENCE TO RELATED APPLICATION

The present application is based on and claims priority under 35 U.S.C. § 119 with respect to the Japanese Patent Application No. 2024-053954 filed on Mar. 28, 2024, of which entire content is incorporated herein by reference into the present application.

### TECHNICAL FIELD

The present disclosure relates to a composite powder for use in manufacturing a porous body contained in an anode body of an electrolytic capacitor, a manufacturing method of the composite powder, and a manufacturing method of an anode body for an electrolytic capacitor.

### BACKGROUND

In recent years, electrolytic capacitors with small equivalent series resistance (ESR) and excellent frequency characteristics have been under development. The anode body in such an electrolytic capacitor includes a porous body containing a valve metal and a dielectric layer covering the porous body, for example. The raw material for the porous body is a raw material powder containing a valve metal to which an additive (binder) is added, for example.

Japanese Laid-Open Patent Publication No. 2022-533161 proposes a “solid electrolytic capacitor including a capacitor element, the capacitor element including a sintered porous anode body, a dielectric arranged on the anode body, and a solid electrolyte arranged on the dielectric and including a conductive polymer and a depolarizer”. Japanese Laid-Open Patent Publication No. 2022-533161 takes a powder containing tantalum as an example of a powder for use in forming the sintered porous anode body, and takes polystyrene and the like as specific examples of a binder for use in aggregating the particles of the powder.

Japanese Laid-Open Patent Publication No. 2020-500260 proposes “tantalum powder containing tantalum, hydrogen doped in the tantalum, and nitrogen doped in the tantalum, wherein the value (H/BET) obtained by dividing the hydrogen (H) content (ppm) of the tantalum powder by the Brunauer-Emmett-Teller (BET) surface area (m²/g) of the tantalum powder exceeds 100, and the tantalum powder has (a) a hydrogen content of 300 ppm to 1200 ppm, (b) a nitrogen content of 500 ppm to 3,500 ppm, and (c) a BET range of 3 m²/g to about 10 m²/g”. Japanese Laid-Open Patent Publication No. 2020-500260 takes naphthalene and the like as specific examples of a binder added to the tantalum powder.

Japanese Laid-Open Patent Publication No. 2003-509583 proposes “a production method of an anode for an electrolytic capacitor, the method including the steps of combining a metal powder and an effective amount of dimethyl sulfone as a binder, pressing the powder and dimethyl sulfone to form an anode body, and removing the dimethyl sulfone”.

Japanese Laid-Open Patent Publication No. 2013-135211 proposes “a sintering method of a tantalum capacitor anode element, the method including placing a tantalum anode element obtained by compression molding a tantalum powder mixed with an adhesive into a drying furnace filled with a degreasing solvent, and subjecting the tantalum anode element to sealed low-temperature solvent catalytic wet dewaxing, and vacuum drying and further vacuum sintering the tantalum anode element”. Japanese Laid-Open Patent Publication No. 2013-135211 takes benzoic acid and the like as specific examples of an adhesive.

Japanese Laid-Open Patent Publication No. 2007-273710 proposes “a manufacturing method of an element for a solid electrolytic capacitor, the method including pressure-molding a valve metal powder containing a binder to obtain a molded element, and sintering the molded element in vacuum, wherein the molded element is immersed in pure water and subjected to ultrasonic vibrations”. Japanese Laid-Open Patent Publication No. 2007-273710 takes benzoic acid and the like as specific examples of a binder.

### SUMMARY

There is a demand for improved reliability of a porous body contained in an anode body of an electrolytic capacitor.

One aspect of the present disclosure relates to a composite powder for use in manufacturing a porous body contained in an anode body of an electrolytic capacitor, the composite powder including a raw material powder containing a valve metal and an aromatic compound (excluding naphthalene and a polymer) adhered to surfaces of particles of the raw material powder, and the aromatic compound has a melting point of 35° C. or more and 120° C. or less.

Another aspect of the present disclosure relates to a manufacturing method of a composite powder for use in manufacturing a porous body contained in an anode body of an electrolytic capacitor, the manufacturing method includes the steps of preparing a raw material powder containing a valve metal, preparing an additive solution containing an aromatic compound (excluding naphthalene and a polymer) having a melting point of 35° C. or more and 120° C. or less, and a solvent, adding the additive solution to the raw material powder while stirring the raw material powder to obtain the raw material powder in a wet state, and removing the solvent by drying the raw material powder in the wet state while stirring to obtain a composite powder, and the composite powder includes the raw material powder and the aromatic compound adhered to surfaces of particles of the raw material powder.

Another aspect of the present disclosure relates to a manufacturing method of an anode body for an electrolytic capacitor, the manufacturing method includes the steps of preparing a composite powder including a raw material powder containing a valve metal and an aromatic compound (excluding naphthalene and a polymer) adhered to surfaces of particles of the raw material powder, charging the composite powder into a predetermined mold and pressure-molding the composite powder to obtain a molded body, removing the aromatic compound contained in the molded body, sintering the molded body from which the aromatic compound has been removed to obtain a porous body, and forming a dielectric layer on a surface of the porous body to obtain an anode body, and the aromatic compound has a melting point of 35° C. or more and 120° C. or less.

According to the present disclosure, it is possible to improve the reliability of a porous body included in an anode body of an electrolytic capacitor.

### BRIEF DESCRIPTION OF THE DRAWINGS

FIG. 1 is a diagram showing an example of wet mixing of a raw material powder and an aromatic compound A.

FIG. 2A is a diagram showing an example of a process of producing a molded body from a composite powder, and showing a state in which the composite powder is being weighed.

FIG. 2B is a diagram showing an example of a process of producing a molded body from a composite powder, and showing a state of the composite powder before pressure-molding.

FIG. 2C is a diagram showing an example of a process of producing a molded body from a composite powder, and showing the state of the composite powder during pressure-molding.

FIG. 3 is a configuration diagram showing an example of equipment used in a step of removing the aromatic compound A and a step of sintering the molded body.

FIG. 4 is a schematic cross-sectional view of an electrolytic capacitor according to an embodiment of the present disclosure.

FIG. 5 is a cross-sectional diagram showing a state in which powder is charged into a jig set for bulk density measurement.

FIG. 6 is a schematic perspective view of a porous body (sintered body) for describing an evaluation method in an example.

### DETAILED DESCRIPTION

Hereinafter, embodiments of the present disclosure will be described taking examples, but the present disclosure is not limited to the examples described below. In the following description, specific numerical values and materials may be exemplified, but other numerical values and materials may be applied as long as the effects of the present disclosure are obtained. The description “numerical value A to numerical value B” herein includes numerical value A and numerical value B, and can be read as “numerical value A or more and numerical value B or less”. In the following description, if lower limits and upper limits are exemplified for numerical values of specific physical properties or conditions, any of the exemplified lower limits and any of the exemplified upper limits can be combined as desired as long as the lower limit is not equal to or greater than the upper limit. If a plurality of materials are exemplified, one of them may be selected and used alone, or two or more may be used in combination.

An anode body of an electrolytic capacitor includes a porous body (porous sintered body) containing a valve metal and a dielectric layer covering the surface of the porous body. The present disclosure relates to a composite powder for use in manufacturing the porous body contained in the anode body of the electrolytic capacitor. The composite powder according to an embodiment of the present disclosure includes a raw material powder containing a valve metal and an aromatic compound (excluding naphthalene and a polymer) attached to the surfaces of particles of the raw material powder. The aromatic compound has a melting point of 35° C. or more and 120° C. or less.

Hereinafter, the aromatic compound (excluding benzoic acid, naphthalene, and a polymer) having a melting point of 35° C. or more and 120° C. or less will also be referred to as “aromatic compound A”. The particles of the raw material powder will also be referred to as “raw material particles”. The particles of the composite powder include the raw material particles and the aromatic compound A attached to the surfaces of the raw material particles. Hereinafter, the particles of the composite powder will also be referred to as “composite particles”.

In the composite powder of the present disclosure, the aromatic compound A is added as an additive to the raw material powder. In such a composite powder, the weighing stability (fluidity) of the powder can be enhanced. This reduces the mass variation between porous bodies (between molded bodies). In addition, in such a composite powder, the bulk density of the composite powder can be decreased. This reduces the density variation within the molded body, so that it is possible to obtain the porous body (sintered body) with a small density variation in the sintering step, and suppress the occurrence of chipping, cracking, and the like due to the presence of locally low-density areas in the molded body (porous body). The reduction in density variation makes it easy to form a homogeneous dielectric layer and solid electrolyte layer throughout the porous body, so that it is possible to reduce the characteristic variation of electrolytic capacitors, decrease the failure rate, and enhance the reliability. Furthermore, if the additive is the aromatic compound A, it is possible to reduce the content of carbon derived from the additive of the porous body, and suppress the increase in leakage current with a high carbon content. Since the carbon content of the porous body is decreased and the mass variation between porous bodies and the density variation within the porous body are reduced, the porous body and the electrolytic capacitor manufactured using the porous body can be enhanced in reliability.

The aromatic compound A has a melting point of 35° C. or more and is stable in a solid state at room temperature (approximately 20 to 25° C.). Therefore, the composite powder can be obtained as a dry powder and maintained with a low bulk density, so that a porous body (molded body) with small density variation can be stably obtained and excellent weighing stability can be ensured. From the viewpoints of facilitating the manufacture of the composite powder, ensuring high productivity, and improving weighing stability, the melting point of the aromatic compound may be 40° C. or more, or may be 45° C. or more.

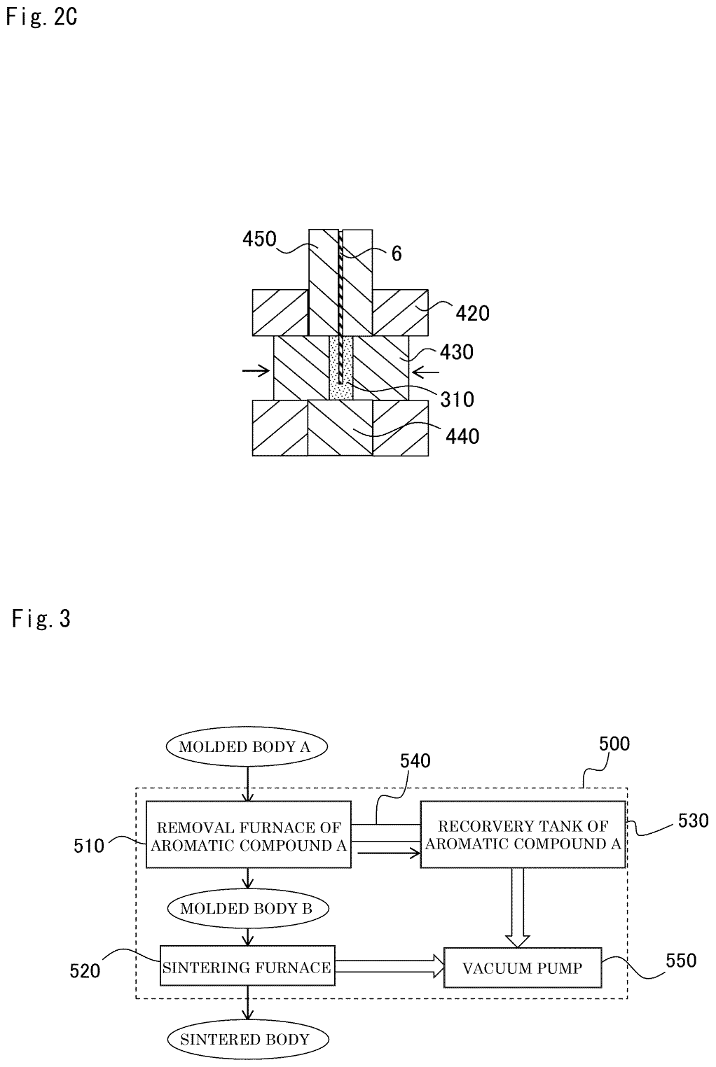

The melting point of the aromatic compound A is 120° C. or less. In this case, the step of removing an aromatic compound A described later can be easily performed at low cost. A highly reliable porous body (anode body) with a reduced carbon content can be obtained at low cost while ensuring high productivity of the porous body. In the step of removing the aromatic compound A using the equipment in FIG. 3, the pipe from the removal furnace to the recovery tank of the aromatic compound A (heat-retention pipe 540 in FIG. 3) is kept at about 120 to 150° C., thereby suppressing the aromatic compound from adhering to the inner wall of the pipe. There is no need to install a pipe with a heat-resistant structure or to add equipment for heating the pipe to 150° C. or higher, which is advantageous in terms of cost. From the viewpoints of improving productivity, reducing costs, and improving reliability, the melting point of the aromatic compound is preferably 100° C. or less, more preferably 90° C. or less.

If the additive is benzoic acid (a melting point of 122.4° C.), even if the temperature of the above-described pipe is set in the range of about 120 to 150° C., there may be a region in the pipe (or in the vicinity of the pipe in the removal furnace) where the temperature is below 122° C., and the benzoic acid may precipitate and adhere in that region. The presence of this adhered substance decreases the ability to transport the additive from the removal furnace to the recovery tank, which may result in insufficient removal of the additive and decrease the productivity and reliability of the porous body.

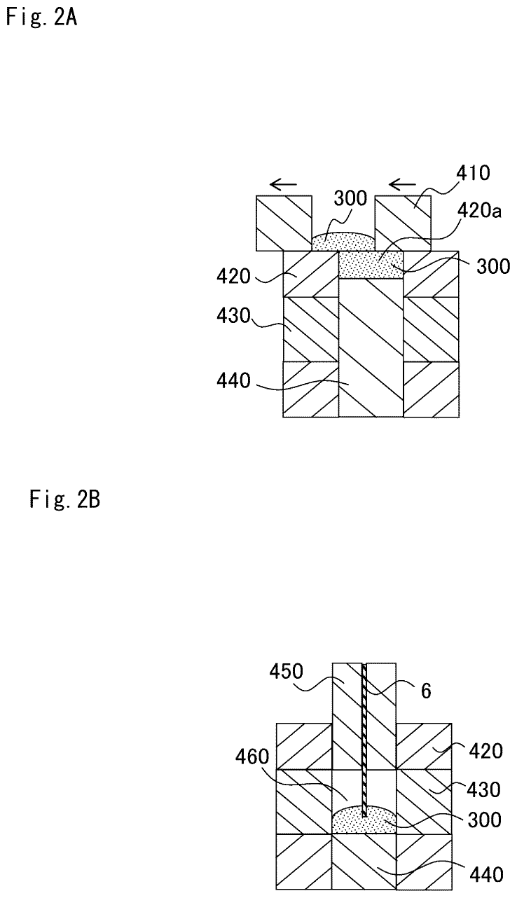

A composite powder containing the aromatic compound A can provide a porous body (molded body) with small density variation. The addition of the aromatic compound A tends to decrease the bulk density of the powder. This decrease in bulk density increases the ratio of the volume (apparent volume of the powder including voids between particles) of composite powder 300 (raw material powder) in space 460 in FIG. 2B, and suppresses the composite powder 300 from being unevenly distributed at the bottom of the space 460 due to gravity. The decrease in bulk density is presumed to be one of the factors that reduces the density variation in the molded body (porous body) when the powder is pressure-molded by a press mold 430 to obtain the molded body. The bulk density of the composite powder in terms of the raw material powder may be lower than the bulk density of the raw material powder. If the additive amount of aromatic compound A is small, the bulk density of the composite powder in terms of the raw material powder may be higher than that of the raw material powder due to the influence of the solvent contained in the additive solution, but the density variation of the porous body (molded body) is reduced and the weighing stability is improved. If the additive amount of aromatic compound A is large, a bulk density D2 of the composite powder in terms of the raw material powder becomes lower than a bulk density D1 of the raw material powder, so that the density variation is more easily reduced and the weighing stability is further improved.

The powder is leveled off and charged into a predetermined weighing hole by leveling. That is, a predetermined amount of powder is charged into the weighing hole of a weighing jig using a leveling tool. For example, the powder 300 is charged into a weighing hole 420a in FIG. 2A using a leveling tool. The bulk density D1 of the raw material powder is calculated by the formula D1=M1/V where M1 is the mass of the raw material powder leveled off and charged into the weighing hole, and V is the volume of the weighing hole.

The bulk density D2 of the composite powder in terms of the raw material powder is calculated by the formula D2=M2a/V where M2a is the mass of the composite powder in terms of the raw material powder leveled off and charged into the weighing hole, and V is the volume of the weighing hole. The mass M2a of the composite powder in terms of the raw material powder is calculated by the formula M2a=M2/(1+ (X/100)) where M2 is the mass of the composite powder leveled off and charged into the weighing hole, and X is the content of the additive in the composite powder (amount (parts by mass) per 100 parts by mass of the raw material powder).

In the composite powder containing the aromatic compound A, the variation in the amount of powder charged into the weighing hole is small, and the mass variation in porous bodies (molded bodies) can be reduced. The powder is weighed by charging the powder 300 into the weighing hole 420a in FIG. 2A, for example.

If the mass variation in porous bodies is large, the surface areas of the porous bodies (anode bodies) will vary greatly, which may increase the variation in the capacitance of electrolytic capacitors. In addition, in the above case, when a plurality of porous bodies are subjected to chemical conversion treatment at the same chemical conversion voltage, the chemical conversion current will vary greatly among the porous bodies, which will increase the variation in the quality of the formed chemical conversion films. This may increase the variation in the leakage current (LC) of the electrolytic capacitors. In this way, the variation in the characteristics of the electrolytic capacitors may increase. As a method for reducing the variation in the characteristics of the electrolytic capacitors, electrolytic capacitors out of a predetermined mass range may be eliminated as defective products at the stage of obtaining the molded bodies. However, in the above case, the molding defect rate increases, which is disadvantageous in terms of productivity.

The boiling point of the aromatic compound A is preferably 400° C. or less (or 350° C. or less). In the step of removing the aromatic compound A, the aromatic compound A can be removed by vaporizing at a temperature of 400 to 500° C. This temperature range is almost the same as the temperature range in which camphor is removed by evaporation and the temperature range in which acrylic resin is removed by thermal decomposition and evaporation, so that the equipment used with camphor or acrylic resin as an additive can be used as is.

The aromatic compound A preferably contains oxygen atoms. The molecules of the aromatic compound A exhibit polarity due to the oxygen atoms, and it is considered that the molecules are easily attached to the surfaces of the raw material particles containing a valve metal due to the Coulomb force based on the polarity. It is presumed that the steric hindrance of the aromatic compound A having an aromatic ring suppresses the aggregation of the raw material particles, and the bulk density of the composite powder is decreased.

From the viewpoint of easily obtaining stable performance of the electrolytic capacitor, the aromatic compound A is preferably constituted of only carbon atoms, hydrogen atoms, and oxygen atoms. If the aromatic compound contains atoms other than carbon atoms, hydrogen atoms, and oxygen atoms, the presence of the other atoms (for example, if the other atoms are sulfur atoms, partial sulfurization of Ta) may affect the performance of the electrolytic capacitor.

The aromatic compound A may contain a heterocycle in which some of the carbon atoms constituting a benzene ring are replaced with oxygen atoms, and an oxygen atom may be bonded to at least one of the carbon atoms constituting the benzene ring. The oxygen atom may be directly bonded to the carbon atom constituting the benzene ring, or may be bonded to the carbon atom constituting the benzene ring via a methylene group (—CH₂—) or an ethylene group (—CH₂CH₂—). It is presumed that the presence of a bond between a carbon atom and an oxygen atom, which is likely to exhibit polarity, in the vicinity of the heterocycle or benzene ring that causes steric hindrance, restricts the arrangement and orientation of the heterocycle or benzene ring, thereby effectively decreasing the bulk density of the composite powder.

The aromatic compound A may have one benzene ring and an oxygen-containing functional group bonded to the benzene ring. Examples of the oxygen-containing functional group include a hydroxyl group, a carboxyl group, a carbonyl group, an ester group, an ether group, and the like. The oxygen-containing functional group may be bonded directly to a carbon atom constituting the benzene ring, or may be bonded to a carbon atom constituting the benzene ring via a methylene group (—CH₂—) or an ethylene group (—CH₂CH₂—). The oxygen-containing functional group may be a divalent functional group and may be bonded to two carbon atoms constituting the benzene ring to form a heterocyclic ring.

The aromatic compound A may be an aromatic compound containing a lactone ring. A lactone ring is a heterocyclic ring containing an ester group (—C(═O)—O—) in the ring. Examples of the aromatic compound containing a lactone ring include coumarin compounds, dehydroacetic acid (with a melting point of 112° C. and a boiling point of 270° C.), and the like. A coumarin compound includes coumarin and its derivatives. Examples of the coumarin compound include coumarin (with a melting point of 72° C. and a boiling point of 302° C.), 6-methylcoumarin (with a melting point of 77° C. and a boiling point of 304° C.), and the like.

The aromatic compound A may be a vanilloid compound. A vanilloid compound is a compound having a vanillyl group. Examples of the vanilloid compound include vanillin compounds, vanillic acid compounds, and the like. A vanillin compound includes vanillin and its derivatives. Examples of the vanillin compound include vanillin (with a melting point of 82° C. and a boiling point of 285° C.), ethyl vanillin (with a melting point 76° C. and a boiling point of 295° C.), and the like. A vanillic acid compound includes vanillic acid and its derivatives. Examples of the vanillic acid compound includes methyl vanillate (with a melting point 65° C. and a boiling point of 287° C.), ethyl vanillate (with a melting point of 43° C. and a boiling point of 293° C.), and the like.

The aromatic compound A preferably contains at least one selected from the group consisting of coumarin (with a melting point of 72° C. and a boiling point of 302° C.), vanillin (with a melting point of 82° C. and a boiling point of 285° C.), thymol (with a melting point of 52° C. and a boiling point of 232° C.), p-methoxyphenol (with a melting point of 58° C. and a boiling point of 243° C.), phenyl salicylate (with a melting point of 44° C. and a boiling point of 137° C.), benzyl (with a melting point of 97° C. and a boiling point of 348° C.), and 3-phenylpropionic acid (with a melting point of 51° C. and a boiling point of 280° C.). These compounds have a high solubility of 10 g or more per 100 g of ethanol or the like described later, a melting point of 35 to 100° C., and a boiling point of 350° C. or less.

Among them, coumarin and vanillin are preferable as the aromatic compound A. These compounds are not corrosive solids, so no special precautions are required for transportation, and they do not fall under the category of Substances Whose Names Should be Notified under the Industrial Safety and Health Act in Japan, so management can be simplified. Since the melting point is as relatively high as 70° C. or more, there is no need to perform special temperature control in the storage environment of the composite powder from the preparation of the composite powder to the production of the molded body. These compounds are known as ingredients contained in foods and the like, and are less harmful to the human body.

The aromatic compound A does not contain a polymer. Examples of the polymer include polystyrene, polycarbonate, polyethylene terephthalate, polybutylene terephthalate, polyimide, polyether ether ketone, and the like. In the case of including a polymer, the additive amount of the aromatic compound A to the raw material powder will be increased in order to improve weighing stability. The polymer cannot be thermally decomposed at 500° C. or less, or even if it is thermally decomposed, the decomposition product will be likely to remain because the polymer is not completely evaporated. This may increase the carbon content in the porous body. In addition, since harmful substances such as benzene and toluene are generated during the thermal decomposition process, special management is required for the recovery and disposal of the decomposition product. If the composite powder is obtained using a polymer, agglomerates (for example, 300 μm or more) of particles tightly adhered to each other by the polymer are likely to be formed after the solvent removal process. The agglomerates are likely to cause problems such as increased variation in the charging of the powder into the weighing hole, increased density variation in the porous body (molded body), and formation of a sintered body distorted in shape, so that the reliability of the porous body will tend to decrease. This requires a separate process for removing the agglomerates, which leads to a loss of powder and is disadvantageous in terms of productivity.

The aromatic compound A does not contain naphthalene. Naphthalene is an aromatic compound with a melting point of 79° C., but is one of specified chemical substances in Japan, is harmful, and is difficult to handle. Naphthalene is a substance that is specified as having a permissible concentration of 10 ppm or less in time-weighted average (TWA) by the American Conference of Governmental Industrial Hygienists (ACGIH).

The content of the aromatic compound A in the composite powder is preferably 0.01 parts by mass or more per 100 parts by mass of the raw material powder. If the content of the aromatic compound A is 0.01 parts by mass or more, favorable weighing stability of the composite powder is easily ensured, and the porous body (molded body) with small density variation is obtained. As the content of the aromatic compound A is larger, the weighing stability of the composite powder tends to be more increased, the bulk density of the composite powder in terms of the raw material powder tends to be smaller, and the coarse/dense distribution index of the sintered body side surface described later tends to be smaller. The content of the aromatic compound A in the composite powder may be 0.01 parts by mass or more and 2 parts by mass or less per 100 parts by mass of the raw material powder. If the content of the aromatic compound A is 2 parts by mass or less, the carbon content of the porous body is reduced, and the leakage current is reduced.

From the viewpoint of further improving the weighing stability and further reducing the density variation of the porous body (molded body), the content of the aromatic compound A may be 0.5 parts by mass or more and 2 parts by mass or less per 100 parts by mass of the raw material powder. From the viewpoint of further reducing leakage current (the carbon content of the porous body), the content of the aromatic compound A may be 0.01 parts by mass or more and 0.5 parts by mass or less per 100 parts by mass of the raw material powder. If the content of the aromatic compound A exceeds 0.5 parts by mass, the leakage current can be sufficiently reduced by introducing the step of immersing the molded body in an organic solvent before the heating step into the step of removing the aromatic compound A described later.

If the additive is an acrylic polymer, the carbon content of the porous body may become large, and the leakage current (LC) may increase. Although the detailed cause is unclear, it is considered that a large amount of acrylic polymer needs to be added (for example, 1 part by mass or more of acrylic polymer needs to be added to 100 parts by mass of the raw material powder) to improve weighing stability, so that a part of the pyrolysis product generated by pyrolysis in the step of removing the additive is likely to remain without being removed by evaporation. Examples of the acrylic polymer include poly(meth)acrylic acid and its salts, polymers of (meth)acrylic acid esters (acrylic resins), and the like. “(Meth)acrylic acid” means at least one selected from the group consisting of “acrylic acid” and “methacrylic acid”. In addition, even if a step of eluting the acrylic polymer by immersing a molded body made of a composite powder containing an acrylic polymer in toluene is provided as the step of removing the additive, the acrylic polymer firmly adhered to inside of the molded body is likely to remain, making it difficult to reduce the carbon content of the porous body and difficult to obtain the effect of suppressing leakage current.

The content of the additive (aromatic compound A) in the composite powder (amount per 100 parts by mass of the raw material powder) can be determined as described below. The composite powder is put into an organic solvent such as ethanol, stirred, and then the raw material powder (for example, Ta powder) and the liquid (a solution containing the additive) are separated by filtration, centrifugation, or the like. The liquid is dried to obtain a precipitate (additive). The masses of the raw material powder and the precipitate are measured, and the mass ratio (percentage) of the precipitate to the raw material powder is determined.

The components of the additive can be determined by gas chromatography mass spectrometry, for example. The above-mentioned melting point and boiling point are measured by a general method as described in the Japanese Industrial Standards (JIS), for example. If necessary, the melting point may be measured by differential scanning calorimetry (DSC). If necessary, the boiling point may be measured by thermogravimetry/differential thermal analysis (TG/DTA).

### (Raw Material Powder)

The raw material powder contains a valve metal. Examples of the valve metal include aluminum (Al), titanium (Ti), tantalum (Ta), niobium (Nb), zirconium (Zr), hafnium (Hf), and the like. The raw material particles may be particles of a valve metal, particles of an alloy containing a valve metal, or particles of a compound containing a valve metal. Only one type of particles may be used, or two or more types may be mixed together.

The average particle size of the raw material powder may be 100 μm or less, or may be 80 μm or less. In this case, it is possible to suppress an increase in the density variation of the molded body due to uneven distribution of coarse particles in part of the molded body, and improve the flatness of the surface of the molded body, thereby reducing the dimensional variation of the molded body. In addition, since it is relatively difficult to achieve the average particle size 100 μm or more of a powder with a CV value of 100 μFV/g (100 kCV) or more, there is also an advantage of providing broad options in selecting raw material powder. The addition of the aromatic compound A can improve the weighing stability of raw material powder with an average particle size of 100 μm or less. If camphor is added to raw material powder with an average particle size of 100 μm or less, the weighing stability of the powder may decrease.

From the viewpoint of suppressing the powder from flying into the air, the average particle size of the raw material powder may be 10 μm or more. In this case, it is possible to suppress the powder loss due to the powder flying into the air during transfer from one container to another, and reduce the risk of the worker inhaling the powder. It is also possible to suppress the scattering of particles from the gaps in the molded member due to the small particle size.

The average particle size here is the median diameter (D50) in the volume particle size distribution determined by a laser-diffraction particle size distribution measurement device.

### [Manufacturing Method of Composite Powder]

A manufacturing method of a composite powder according to an embodiment of the present disclosure includes a step of preparing a raw material powder containing a valve metal, a step of preparing a solution of the aromatic compound A (hereinafter, also referred to as “additive solution A”), a step of mixing the raw material powder with the additive solution A, and a step of removing the solvent.

In the case of adding a small amount (for example, 2 parts by mass or less or 1 part by mass or less) of the aromatic compound A to 100 parts by mass of the raw material powder, the aromatic compound A is dissolved in a solvent and mixed with the raw material powder to obtain the raw material powder in a wet state (wet mixing), thereby producing a homogeneous composite powder. In the case of dry-mixing a small amount of the aromatic compound A with the raw material powder at a temperature equal to or higher than the melting point of the aromatic compound A, it is difficult to spread the small amount of the molten aromatic compound A over the entire surface of the raw material powder, making it unlikely to produce a homogeneous composite powder. In addition, according to this method, the molten aromatic compound A is likely to adhere to the wall of the mixing container, and the proportion of the aromatic compound A that does not contribute to the compounding may increase, so that it is difficult to adjust the additive amount of the aromatic compound A to the raw material powder.

### (Step of Preparing Raw Material Powder)

The raw material powder may be any of those exemplified above.

### (Step of Preparing Additive Solution A)

The additive solution A contains the aromatic compound A and a solvent. The aromatic compound A may be any of those exemplified above. The concentration of the aromatic compound A in the additive solution A is 0.005% by mass or more and 10% by mass or less, for example. If it is necessary to lower the concentration of the additive solution A, the additive solution A of high concentration may be prepared first, and then the solution A may be diluted with a solvent to lower the concentration.

The solvent is preferably a solvent that is relatively less harmful, rather than a highly harmful solvent such as toluene. Examples of the solvent that is relatively less harmful include ethanol, isopropanol, and butyl acetate (hereinafter, also referred to as “ethanol and the like”). One type of the solvent may be used alone or two or more types may be used in combination.

The solvent is preferably ethanol, isopropanol, or butyl acetate, and the solubility of the aromatic compound A in 100 g of the solvent at 20° C. is preferably 10 g or more. It is preferable that the solubility of the aromatic compound A in at least one of the three solvents is within the above range. In this case, the dissolution rate of the aromatic compound A in the solvent is fast, and the additive solution A can be easily prepared. In this case, the occurrence of uneven mixing is sufficiently suppressed, and the raw material particles and the aromatic compound A can be easily mixed homogeneously.

### (Step of Mixing Raw Material Powder and Additive Solution a)

This step is a step of wet-mixing the raw material powder and the aromatic compound A. That is, in the mixing step, the additive solution is added to the raw material powder while the raw material powder is stirred, thereby obtaining the raw material powder in a wet state.

The additive amount of the aromatic compound A may be 0.01 parts by mass or more and 2 parts by mass or less per 100 parts by mass of the raw material powder. If the additive amount of the aromatic compound A is 2 parts by mass or less, the carbon content of the porous body is sufficiently reduced. If the additive amount of the aromatic compound A is 0.01 parts by mass or more, it is easy to obtain a composite powder with excellent weighing stability, and it is easy to reduce density variation in the porous body (molded body).

From the viewpoint of sufficiently suppressing the occurrence of uneven mixing and easily obtaining a homogeneous composite powder, the additive amount of the additive solution A is preferably 5 parts by mass or more and 20 parts by mass or less per 100 parts by mass of the raw material powder. If the additive amount of the additive solution A is within the above range, it is easy to adjust the entire raw material powder to a moderately wet state. If the additive amount of the additive solution A is small, it may be difficult for the aromatic compound A to be uniformly distributed throughout the entire raw material powder. If the additive amount of the additive solution A is large, the raw material powder enters a slurry state, and large amounts of the additive solution A and raw material powder may adhere to the wall of the mixing container, and a large amount of the aromatic compound A may precipitate on the wall of the mixing container during drying (the step of removing the solvent).

### (Step of Removing Solvent)

In the step of removing the solvent, the raw material powder in a wet state is dried while being stirred to remove the solvent, thereby obtaining a composite powder. The composite powder contains the raw material powder and the aromatic compound A adhered to the surfaces of particles of the raw material powder. The raw material powder can be dried by heating, reducing pressure, or the like. If the solvent is ethanol, the raw material powder may be dried by heating at about 50 to 90° C.

In the case of drying by heating, it is preferable to maintain the stirring state until the temperature of the raw material powder falls below the melting point of the aromatic compound A. If the stirring is stopped before the temperature of the raw material powder falls below the melting point of the aromatic compound A, the molten aromatic compound A may move to cause uneven mixing.

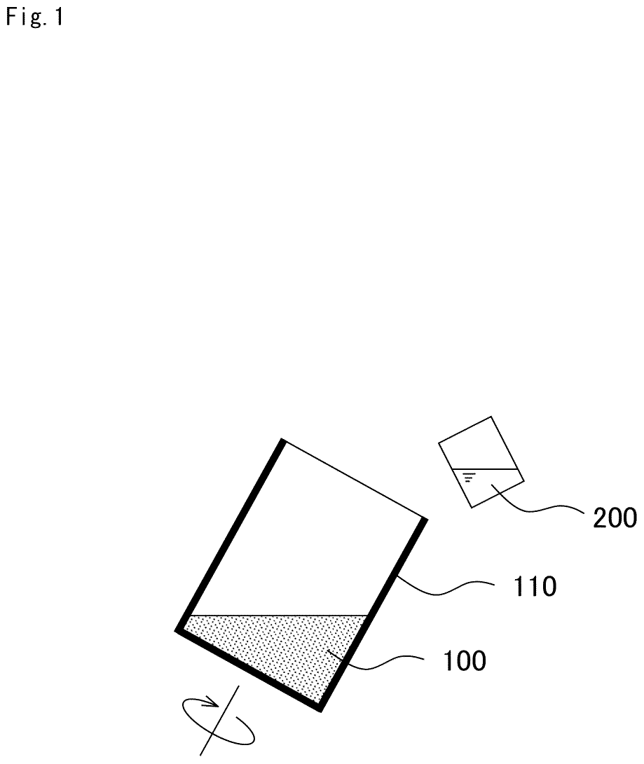

FIG. 1 is a diagram showing an example of wet-mixing of the raw material powder and the aromatic compound A. Raw material powder 100 is placed in a mixing container 110. A solution 200 of the aromatic compound A is added to the raw material powder 100 while the raw material powder 100 is stirred. In this manner, the raw material powder 100 in a wet state is obtained. Thereafter, the wet raw material powder 100 in the mixing container 110 is dried while being stirred to remove the solvent. In this manner, a composite powder is obtained.

### [Manufacturing Method of Anode Body for Electrolytic Capacitor]

An anode body for electrolytic capacitor according to an embodiment of the present disclosure includes a step of preparing composite powder, a step of molding composite powder, a step of removing the aromatic compound A, a step of sintering a molded body, and a step of forming a dielectric layer.

### (Step of Preparing Composite Powder)

In this step, the composite powder of the present disclosure is prepared. In this step, for example, the composite powder obtained by the above-described manufacturing method is prepared.

### (Step of Molding Composite Powder)

In the step of molding composite powder, the composite powder is charged into a predetermined mold and pressure-molded to obtain a molded body. This molded body contains the aromatic compound A. In this step, a portion of the anode wire may be embedded in the molded body. Since the aromatic compound A is contained in the composite powder, the mass variation between molded bodies is reduced. In addition, the density variation in the molded body is reduced, and sufficient density is ensured even at the ends that tend to have locally low density, so that the strength is ensured to suppress the occurrence of cracks and chips at the ends of the molded body.

FIGS. 2A to 2C are diagrams showing an example of a process of producing a molded body from a composite powder.

First, as shown in FIG. 2A, composite powder 300 is poured into a weighing hole 420a having a certain volume, which is formed by a weighing mold 420 and a lower mold 440, and the composite powder 300 is charged into the weighing hole 420a using a leveling slider 410. In this manner, the composite powder 300 is weighed. The composite powder 300 containing the aromatic compound A has excellent weighing stability, and the weighing can be stably performed by charging the powder 300 into the weighing hole 420a using the leveling slider 410.

Next, as shown in FIG. 2B, the weighed composite powder 300 is placed in a predetermined space 460 formed by a press mold 430 and the lower mold 440. After that, an upper mold 450 is arranged above the space 460, and an anode wire 6 is inserted into a predetermined hole of the upper mold 450 so that a portion of the anode wire 6 is arranged in the space 460.

Next, as shown in FIG. 2C, the press mold 430 is moved in the directions of arrows to pressure-mold the composite powder 300. In this manner, a molded body 310 is formed in which a portion of the anode wire 6 is embedded.

For example, as shown in FIGS. 2B and 2C, the powder 300 is piled up at the bottom of the space 460, and then the powder 300 is risen by the press mold 430 to form the molded body 310. In the case of producing a molded body using raw material powder without adding the aromatic compound A, the density variation in the molded body increases such that the density is higher at the bottom and lower at the top. In particular, the upper corners are low in strength, and are likely to suffer from cracking and chipping. In contrast, in the case of producing a molded body using the composite powder of the present disclosure containing the aromatic compound A, the density difference in the vertical direction (gravity direction) of the composite powder in the space is small, the density variation in the molded body is small, and the decrease in the strength of the corners is suppressed. The composite powder has a low bulk density, and the volume of the powder 300 piled up at the bottom of the space 460 (apparent volume of the powder including voids between particles) is large. In addition, since the aromatic compound A is adsorbed to the raw material powder, friction between particles in the composite powder is reduced, and the powder 300 can easily rise upward in the space 460 during pressure-molding using the press mold 430. It is presumed that these factors contribute to the reduction of density variation in the molded body.

### (Step of Removing Aromatic Compound A)

In the step of removing the aromatic compound A, the aromatic compound A contained in the molded body is removed. The amount of the aromatic compound A remaining in the molded body can be reduced by the removing step. Accordingly, the carbon content derived from the aromatic compound A in the sintered body obtained in the subsequent step can be sufficiently reduced.

For example, the aromatic compound A contained in the molded body may be removed by vaporization. That is, the removing step may include a step (heating step) of heating the molded body to a predetermined temperature (a temperature equal to or higher than the boiling point of the aromatic compound A) under reduced pressure. When the boiling point of the aromatic compound A is 400° C. or less, the aromatic compound A can be removed at a temperature of about 400 to 500° C. under reduced pressure. The reduced pressure in the removing step may be under vacuum, or may be under an atmosphere in which a small amount of inert gas such as Ar gas is flown while evacuation is being performed using a vacuum pump.

The removing step may also include a step (immersion step) of immersing the molded body in an organic solvent to dissolve the aromatic compound A in the organic solvent. In the immersion step, the molded body may be immersed while being shaken. Examples of the organic solvent include ethanol, isopropanol, and butyl acetate. In the removing step, it is preferable to perform the immersion step and then the heating step. In this case, the carbon content derived from the aromatic compound A in the sintered body obtained in the subsequent step can be further reduced. In the case of removing the aromatic compound A by heating the molded body with a large additive amount of the aromatic compound A (for example, the additive amount of the aromatic compound A is 1 part by mass), the heating time required for removal may be long. In this case, using the immersion step and the heating step in combination makes it possible to quickly and easily remove the aromatic compound A even if the additive amount of the aromatic compound A is large.

### (Step of Sintering Molded Body)

In the step of sintering the molded body, the molded body from which the aromatic compound A has been removed is sintered to obtain a porous body (sintered body). Details of the porous body will be described later. The molded body can be sintered under reduced pressure at a temperature of 1200 to 1500° C., for example. The reduced pressure in the sintering step is preferably under high vacuum.

FIG. 3 is a configuration diagram showing an example of equipment used in the step of removing the aromatic compound A (heating step) and the step of sintering the molded body. In FIG. 3, a molded body A is a molded body containing the aromatic compound A (a molded body before the step of removing the aromatic compound A (heating step) (including a molded body after the immersing step)), and a molded body B is a molded body after the step of removing the aromatic compound A (heating process).

Equipment 500 includes a removal furnace 510 that removes the aromatic compound A from the molded body A to obtain the molded body B, a sintering furnace 520 that sinters the molded body B, a recovery tank 530 that recovers the aromatic compound A having been removed from the molded body A, a heat-retention pipe 540, and a vacuum pump 550. The heat-retention pipe 540 is arranged between the removal furnace 510 and the recovery tank 530.

The temperature inside the heat-retention pipe 540 is adjusted to a temperature equal to or higher than the melting point of the aromatic compound A. This suppresses precipitation of the aromatic compound A inside the pipe 540. For example, when the melting point of the aromatic compound A is 120° C. or less (or 100° C. or less), the temperature inside the pipe 540 is maintained at about 120 to 150° C. This eliminates the need for providing a pipe with a special heat-retention structure, which is advantageous in terms of manufacturing costs.

The heat-retention pipe 540 and the recovery tank 530 are arranged between the removal furnace 510 and the vacuum pump 550. The insides of the removal furnace 510, the heat-retention pipe 540, and the recovery tank 530 are depressurized by the vacuum pump 550. The inside of the sintering furnace 520 is also depressurized by the vacuum pump 550. The recovery tank 530 is cooled with liquid nitrogen or the like, and the aromatic compound A is solidified and recovered. Valves may be provided between the removal furnace 510 and the sintering furnace 520, between the removal furnace 510 and the heat-retention pipe 540, between the heat-retention pipe 540 and the recovery tank 530, between the recovery tank 530 and the vacuum pump 550, and between the sintering furnace 520 and the vacuum pump 550. The valves may be opened and closed depending on the location and timing at which depressurization is required.

The removing step (heating step) and the sintering step using the equipment in FIG. 3 will be described below.

The molded body A is supplied to the removal furnace 510 under reduced pressure, where the aromatic compound A is removed from the molded body A, thereby producing the molded body B. Next, the molded body B is supplied to the sintering furnace 520 under reduced pressure and sintered, thereby producing a sintered body. Meanwhile, the aromatic compound A having been removed by evaporation in the removal furnace 510 passes through the heat-retention pipe 540 and is recovered in the recovery tank 530.

Referring to FIG. 3, the removal furnace and the sintering furnace are provided separately, but a single furnace may be provided that functions as both a removal furnace and a sintering furnace. That is, the removing step and the sintering step may be performed in a single furnace. The removal furnace and/or the sintering furnace may be configured as a single furnace or may be configured as a plurality of furnaces. As for the vacuum pump, a vacuum pump connected to the recovery tank and a vacuum pump connected to the sintering furnace may be provided separately.

### (Step of Forming Dielectric Layer)

In the step of forming a dielectric layer, a dielectric layer is formed on the surface of the porous body to obtain an anode body. The dielectric layer is formed by chemical conversion treatment, for example. The details of the dielectric layer will be described later. Reducing the carbon content of the porous body improves the film quality of the dielectric layer formed by chemical conversion treatment, and increases the performance of the electrolytic capacitor. For example, the leakage current of the electrolytic capacitor can be reduced.

Hereinafter, the electrolytic capacitor will be described in detail.

### [Electrolytic Capacitor]

The electrolytic capacitor includes a capacitor element. The capacitor element includes an anode body and a cathode part. The anode body includes a porous body and a dielectric layer covering the surface of the porous body. The cathode part is formed so as to cover the dielectric layer. The cathode part includes at least a solid electrolyte layer. The anode body may include a rod-shaped anode wire partly embedded in the porous body. If the porous body has the shape of a rectangular parallelepiped, the anode wire is planted from one end face of the rectangular parallelepiped. The anode wire may contain a valve metal. A portion of the anode wire is embedded in the porous body, and the remainder protrudes from the porous body. The remainder is connected to an anode lead terminal by welding or the like.

### (Porous Body)

The porous body contains a valve metal. The valve metal may be aluminum (Al), titanium (Ti), tantalum (Ta), niobium (Nb), zirconium (Zr), or hafnium (Hf).

The porous body is a sintered product of a molded body of raw material particles (raw material powder) containing a valve metal. The particles may be particles of a valve metal, particles of an alloy containing a valve metal, or particles of a compound containing a valve metal. Only one type of particles may be used, or two or more types may be used in mixture.

The porous body can be obtained by pressure-molding raw material particles into a predetermined shape to obtain a molded body, and then sintering the molded body. For example, an anode wire may be placed at a predetermined position in a mold, raw material particles may be charged into the mold and pressure-molded to obtain a molded body. The molded body may be sintered to obtain a porous body in which a portion of the anode wire is embedded. The porous body usually has the shape of a rectangular parallelepiped.

### (Dielectric Layer)

The dielectric layer is formed so as to cover the outer surface of the porous body and the inner wall surfaces of pores of the porous body. The dielectric layer is formed by subjecting the porous body to chemical conversion treatment and growing an oxide film on the surface of the porous body, for example. The chemical conversion treatment may be performed by immersing the porous body in a chemical conversion solution to anodize the surface of the porous body. Alternatively, the surface of the porous body may be oxidized by heating the porous body in an atmosphere containing oxygen.

### (Solid Electrolyte Layer)

The solid electrolyte layer is arranged so as to cover at least a portion of the dielectric layer. The solid electrolyte layer may be charged in the pores of the porous body via the dielectric layer and formed on the outer surface of the porous body. The solid electrolyte layer may be a laminate of two or more different solid electrolyte layers.

The solid electrolyte layer includes a conductive polymer. The conductive polymer may be a π-conjugated polymer, and examples of the conductive polymer include polypyrrole, polythiophene, polyaniline, and derivatives thereof. These may be used alone or in combination. The conductive polymer may be a copolymer of two or more monomers. The derivative of a conductive polymer means a polymer having a conductive polymer as a basic skeleton. Examples of a polythiophene derivative includes poly(3,4-ethylenedioxythiophene) (PEDOT) and the like.

A dopant may be added to the conductive polymer. That is, the solid electrolyte layer may contain a conductive polymer and a dopant. The conductive polymer may be contained in the solid electrolyte layer in a state of being doped with the dopant. The dopant can be selected according to the conductive polymer, and a known dopant may be used. Examples of the dopant include benzenesulfonic acid, alkylbenzenesulfonic acid, naphthalenesulfonic acid, alkylnaphthalenesulfonic acid, polystyrenesulfonic acid (PSS), and salts thereof. The solid electrolyte layer contains PEDOT doped with PSS, for example.

The solid electrolyte layer containing a conductive polymer can be formed by impregnating a porous body (anode body) having a dielectric layer formed on its surface with a first treatment liquid containing a monomer (or oligomer), and then polymerizing the monomer (or oligomer) by electrolytic polymerization or chemical polymerization, for example. In the case of chemical polymerization, the first treatment liquid contains a monomer (or oligomer), an oxidizing agent, and a solvent (or dispersion medium), for example. Examples of the monomer include 3,4-ethylenedioxythiophene (EDOT), pyrrole, and the like. The first treatment liquid may contain a dopant.

Alternatively, the solid electrolyte layer may be formed by impregnating a porous body (anode body) having a dielectric layer formed on its surface with a treatment liquid containing a conductive polymer, and drying the treatment liquid. The treatment liquid contains a conductive polymer, a solvent (or a dispersion medium), and, if necessary, a dopant, for example.

### (Others)

The capacitor element may include a cathode layer covering at least a portion of the solid electrolyte layer. The electrolytic capacitor may include an anode lead terminal and a cathode lead terminal electrically connected to the capacitor element, and an exterior resin arranged around the capacitor element. The cathode lead terminal is connected to the cathode part via a conductive member. The anode lead terminal is connected to an end portion of the anode wire protruding from the porous body. The capacitor element is not particularly limited in shape, size, and the like, and may be a known capacitor element or a capacitor element having a similar configuration to a known capacitor.

### (Cathode Layer)

The cathode layer may include a carbon layer formed on the solid electrolyte layer and a metal paste layer formed on the carbon layer. The carbon layer may be formed of a conductive carbon material such as graphite, and a resin. The metal paste layer may be formed of metal particles (for example, silver particles) and a resin, or may be formed of a known silver paste, for example.

### (Conductive Member)

The cathode layer is connected to the connection part of the cathode lead terminal by a conductive member. That is, the cathode layer (cathode part) is electrically connected to the cathode lead terminal. The conductive member is made of a material having electrical conductivity. The conductive member may be formed using a material containing metal particles (for example, silver particles) and a resin, or may be formed using a known metal paste (for example, silver paste), for example. The conductive member is formed by heating the metal paste. The conductive member may be constituted of a plurality of conductive layers of different types.

### (Exterior Resin)

The exterior resin is arranged around the capacitor element such that the capacitor element is not exposed on the surface of the electrolytic capacitor. The exterior resin insulates the anode lead terminal and the cathode lead terminal. The exterior resin may be a known exterior resin used for electrolytic capacitors. For example, the exterior resin may be formed using an insulating resin material used for sealing capacitor elements. The exterior resin may be formed by placing the capacitor element in a mold, introducing an uncured thermosetting resin and a filler into the mold, and curing the resin by transfer molding, compression molding, or the like.

Examples of the exterior resin include epoxy resin, phenolic resin, silicone resin, melamine resin, urea resin, alkyd resin, polyurethane, polyimide, unsaturated polyester, and the like. The exterior resin may contain a substance other than resin (such as an inorganic filler).

### (Cathode Lead Terminal)

A portion of the cathode lead terminal is exposed from the exterior resin and used as a cathode external terminal. The material for the cathode lead terminal may be any material that can be used as a material for a cathode lead terminal of an electrolytic capacitor. For example, a known material for a cathode lead terminal used in an electrolytic capacitor may be used. The cathode lead terminal may be formed by processing a metal sheet (including a metal plate and a metal foil) made of a metal (copper, copper alloy, or the like) by a known metal processing method.

### (Anode Lead Terminal)

A portion of the anode lead terminal is exposed from the exterior resin and used as an anode external terminal. The material for the anode lead terminal may be any material that can be used as a material for an anode lead terminal of an electrolytic capacitor. For example, a known material for an anode lead terminal used in an electrolytic capacitor may be used. The anode lead terminal may be formed by processing a metal sheet (including a metal plate and a metal foil) made of a metal (copper, copper alloy, or the like) by a known metal processing method.

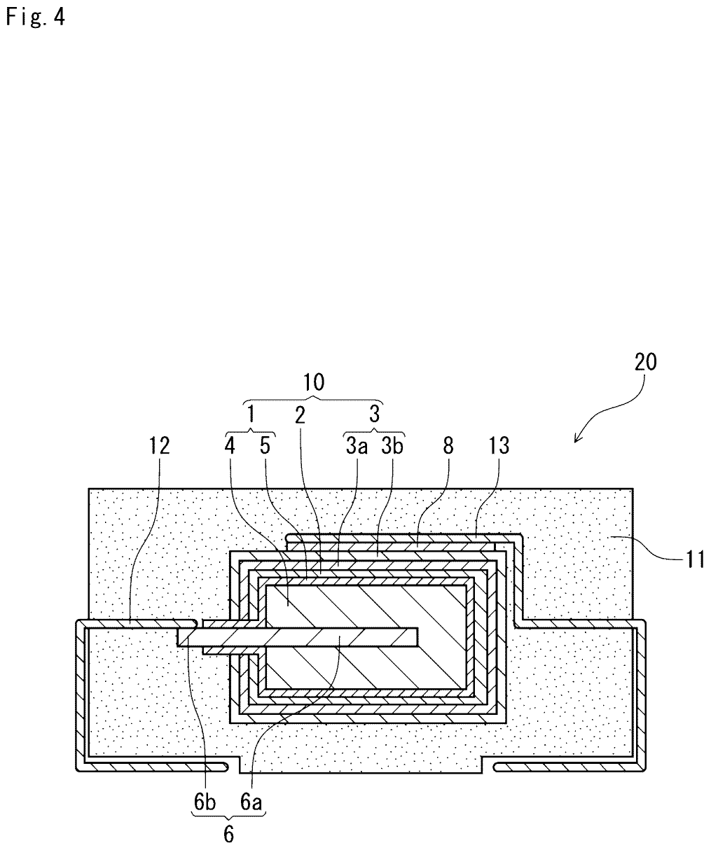

FIG. 4 is a schematic cross-sectional view of an example of an electrolytic capacitor according to the present embodiment. However, the electrolytic capacitor according to the present embodiment is not limited to this example.

An electrolytic capacitor 20 includes a capacitor element 10, an exterior resin 11 that seals the capacitor element 10, and an anode lead terminal 12 and a cathode lead terminal 13 that are electrically connected to the capacitor element 10. The anode lead terminal 12 and the cathode lead terminal 13 are partially exposed from the exterior resin 11. The anode lead terminal 12 and the cathode lead terminal 13 are partially covered by the exterior resin 11 together with the capacitor element 10.

The capacitor element 10 includes an anode body 1, a solid electrolyte layer 2 formed on the anode body 1, and a cathode layer 3 formed on the solid electrolyte layer 2. The anode body 1 includes a porous body 4 containing a valve metal, and a dielectric layer 5 covering the porous body 4. The dielectric layer 5 is formed so as to cover the outer surface of the porous body 4 and the inner wall surfaces of the pores.

The porous body 4 has the shape of a substantially rectangular parallelepiped and has six side surfaces. A portion of the anode wire 6 extends from one side surface of the porous body 4. That is, the anode wire 6 has a first portion 6a that is embedded in the porous body 4 from one side surface of the porous body 4, and a second portion 6b that extends from the one side surface of the porous body 4. The second portion 6b is joined to the anode lead terminal 12 by welding or the like.

The solid electrolyte layer 2 is formed so as to cover at least a portion of the dielectric layer 5. The solid electrolyte layer 2 fills the pores of the porous body 4 (anode body 1). The solid electrolyte layer 2 is formed so as to cover the outer surface of the porous body 4 and the inner wall surfaces of the pores with the dielectric layer 5 in between.

The cathode layer 3 is formed so as to cover the surface of the solid electrolyte layer 2. The cathode layer 3 has a carbon layer 3a formed so as to cover the solid electrolyte layer 2, and a metal paste layer 3b formed on the surface of the carbon layer 3a. The cathode lead terminal 13 is joined to the cathode layer 3 (metal paste layer 3b) with a conductive member 8 in between. The carbon layer 3a contains a conductive carbon material such as graphite, and a resin. The metal paste layer 3b contains metal particles (for example, silver) and a resin, for example. The configuration of the cathode layer 3 is not limited to this configuration. The cathode layer 3 may have any configuration as long as it has a current collecting function.

### Supplementary Remarks

The above description of the embodiments discloses the following technologies:

### (Technology 1)

A composite powder for use in manufacturing a porous body contained in an anode body of an electrolytic capacitor, the composite powder including:
a raw material powder containing a valve metal; and
an aromatic compound (excluding naphthalene and a polymer) adhered to a surface of a particle of the raw material powder,
wherein the aromatic compound has a melting point of 35° C. or more and 120° C. or less

### (Technology 2)

The composite powder according to technology 1, wherein the aromatic compound has a boiling point of 400° C. or less.

### (Technology 3)

The composite powder according to technology 1 or 2, wherein the aromatic compound contains an oxygen atom.

### (Technology 4)

The composite powder according to technology 1 or 2, wherein the aromatic compound is constituted of only a carbon atom, a hydrogen atom, and an oxygen atom.

### (Technology 5)

The composite powder according to technology 1 or 2, wherein in the aromatic compound, some of carbon atoms constituting a benzene ring are substituted with oxygen atoms, or an oxygen atom is bonded to at least one of the carbon atoms constituting the benzene ring.

### (Technology 6)

The composite powder according to technology 1 or 2, wherein the aromatic compound contains at least one selected from the group consisting of coumarin, vanillin, thymol, p-methoxyphenol, phenyl salicylate, benzyl, and 3-phenylpropionic acid.

### (Technology 7)

The composite powder according to any one of technologies 1 to 6,
wherein a solubility of the aromatic compound in 100 g of a solvent at 20° C. is 10 g or more, and
the solvent is ethanol, isopropanol, or butyl acetate.

### (Technology 8)

The composite powder according to any one of technologies 1 to 7, wherein a content of the aromatic compound in the composite powder is 0.01 parts by mass or more and 2 parts by mass or less per 100 parts by mass of the raw material powder.

### (Technology 9)

The composite powder according to any one of technologies 1 to 8, wherein a bulk density of the composite powder is lower than a bulk density of the raw material powder.

### (Technology 10)

The composite powder according to any one of technologies 1 to 9, wherein the anode body includes the porous body containing the valve metal and a dielectric layer covering a surface of the porous body.

### (Technology 11)

A manufacturing method of a composite powder for use in manufacturing a porous body contained in an anode body of an electrolytic capacitor, the manufacturing method including the steps of:
preparing a raw material powder containing a valve metal;
preparing an additive solution containing an aromatic compound (excluding naphthalene and a polymer) having a melting point of 35° C. or more and 120° C. or less, and a solvent;
adding the additive solution to the raw material powder while stirring the raw material powder to obtain the raw material powder in a wet state;
   and
drying the raw material powder in the wet state while stirring to remove the solvent and obtain a composite powder,
wherein the composite powder contains the raw material powder and the aromatic compound adhered to a surface of a particle of the raw material powder.

### (Technology 12)

The manufacturing method of a composite powder according to technology 11, wherein the aromatic compound has a boiling point of 400° C. or less.

### (Technology 13)

The manufacturing method of a composite powder according to technology 11 or 12, wherein the aromatic compound includes at least one selected from the group consisting of coumarin, vanillin, thymol, p-methoxyphenol, phenyl salicylate, benzyl, and 3-phenylpropionic acid.

### (Technology 14)

The manufacturing method of a composite powder according to any one of technologies 11 to 13, wherein a content of the aromatic compound in the composite powder is 0.01 parts by mass or more and 2 parts by mass or less per 100 parts by mass of the raw material powder.

### (Technology 15)

The manufacturing method of a composite powder according to any one of technologies 11 to 14, wherein an additive amount of the additive solution is 5 parts by mass or more and 20 parts by mass or less per 100 parts by mass of the raw material powder.

### (Technology 16)

The manufacturing method of a composite powder according to any one of technologies 11 to 15, wherein the solvent includes at least one selected from the group consisting of ethanol, isopropanol, and butyl acetate.

### (Technology 17)

The manufacturing method of a composite powder according to any one of technologies 11 to 16, wherein the anode body includes the porous body containing the valve metal and a dielectric layer covering a surface of the porous body.

### (Technology 18)

The manufacturing method of a composite powder according to any one of technologies 11 to 17, wherein a solubility of the aromatic compound in 100 g of ethanol, isopropanol, or butyl acetate at 20° C. is 10 g or more.

### (Technology 19)

A manufacturing method of an anode body for an electrolytic capacitor, including the steps of:
preparing a composite powder including a raw material powder containing a valve metal and an aromatic compound (excluding naphthalene and a polymer) adhered to a surface of a particle of the raw material powder;
charging the composite powder into a predetermined mold and pressure-molding the composite powder to obtain a molded body;
removing the aromatic compound contained in the molded body;
sintering the molded body from which the aromatic compound has been removed to obtain a porous body; and
forming a dielectric layer on a surface of the porous body to obtain an anode body,
wherein the aromatic compound has a melting point of 35° C. or more and 120° C. or less.

### (Technology 20)

The manufacturing method of an anode body for an electrolytic capacitor according to technology 19, wherein the aromatic compound has a boiling point of 400° C. or less.

### (Technology 21)

The manufacturing method of an anode body for an electrolytic capacitor according to technology 19 or 20, wherein the aromatic compound includes at least one selected from the group consisting of coumarin, vanillin, thymol, p-methoxyphenol, phenyl salicylate, benzyl, and 3-phenylpropionic acid.

### (Technology 22)

The manufacturing method of an anode body for an electrolytic capacitor according to any one of technologies 19 to 21, wherein a content of the aromatic compound in the composite powder is 0.01 parts by mass or more and 2 parts by mass or less per 100 parts by mass of the raw material powder.

### (Technology 23)

The manufacturing method of an anode body for an electrolytic capacitor according to any one of technologies 19 to 22, wherein the step of removing the aromatic compound contained in the molded body includes a heating step of heating the molded body to vaporize the aromatic compound.

### (Technology 24)

The manufacturing method of an anode body for an electrolytic capacitor according to technology 23,
wherein the step of removing the aromatic compound contained in the molded body includes:
an immersion step of immersing the molded body in an organic solvent to dissolve the aromatic compound in the solvent; and
the heating step to be performed after the immersion step.

### (Technology 25)

The manufacturing method of an anode body for an electrolytic capacitor according to technology 24, wherein the organic solvent is ethanol, isopropanol, or butyl acetate.

### EXAMPLES

Hereinafter, the present disclosure will be specifically described based on examples and comparative examples, but the present disclosure is not limited to the following examples.

### Examples 1 to 7, 9, and 10

### (Production of Composite Powder)

As the raw material powder, Ta powder (average particle size: 80 μm, CV value: 70 kCV (nominal capacitance: 70,000 μF/g)) was prepared. An additive solution containing an additive and a solvent was prepared. As for the additive, coumarin or vanillin was used as the aromatic compound A. Ethanol was used as the solvent. Coumarin and vanillin each have a melting point in the range of 35 to 120° C., a boiling point of 400° C. or lower, and solubility of 10 g or more in 100 g of ethanol.

The additive solution was added to the raw material powder while stirring the raw material powder, thereby to obtain the raw material powder in a wet state (FIG. 1). The amount of the additive was the value (parts by mass) shown in Table 1 per 100 parts by mass of the raw material powder. The concentration of the additive solution was adjusted as appropriate such that the amount of the additive was within the range of 5 to 20 parts by mass per 100 parts by mass of the raw material powder. The raw material powder in the wet state was heated and dried at a temperature of 90° C. or less while being stirred to remove the solvent. In this manner, a composite powder containing the raw material powder and the additive adhered to the surfaces of particles of the raw material powder (Ta particles with the additive adhered to surfaces thereof: composite particles) was obtained.

### (Production of Molded Body)

A predetermined amount of the composite powder was charged into a predetermined mold by leveling and weighing (FIG. 2A). One end of an anode wire was embedded in the portion filled with the composite powder (FIG. 2B). The composite powder was then pressure-molded to obtain a molded body (FIG. 2C). The outer shape of the molded body was a rectangular parallelepiped (0.8 mm×3.7 mm×5.2 mm). A Ta wire was used as the anode wire.

### (Removal of Additive)

The molded body was heated at 400 to 500° C. under reduced pressure to remove the additive contained in the molded body (molded body heating step).

### (Preparation of Sintered Body)

Next, the molded body from which the additive had been removed was sintered at 1300 to 1400° C. under reduced pressure. The sintering temperature and sintering time were adjusted such that the shrinkage rate was about 10%. In this manner, a porous body (Ta sintered body) in which a portion of the anode wire was embedded was obtained.

### Example 8

In the additive removing step, the molded body was subjected to a molded body immersion step, and then the molded body was subjected to the molded body heating step.

Specifically, the molded body immersion step was carried out as described below. The molded body was placed in a stainless steel basket-like container, and the basket-like container containing the molded body was immersed in ethanol in a beaker for 10 minutes. During the immersion, the basket-like container was swung up and down in the beaker at a speed of about one reciprocation per 2 seconds. Thereafter, the basket-like container was removed from the beaker, and the molded body in the basket-like container was transferred to a petri dish and dried at 80° C.

A composite powder was produced, a molded body was produced, and a sintered body was produced in the same manner as in Example 5 except for the above.

### Comparative Example 1

As an additive solution, an acrylic resin solution (solvent: toluene) was prepared instead of a coumarin solution. The additive amount of acrylic resin was 1.5 parts by mass per 100 parts by mass of the raw material powder. A composite powder was produced, a molded body was produced, and a sintered body was produced in the same manner as in Example 1 except for the above.

### Comparative Example 2

As an additive solution, a camphor solution (solvent: methanol) was prepared instead of a coumarin solution. The additive amount of camphor was 1.5 parts by mass per 100 parts by mass of the raw material powder. A composite powder was produced, a molded body was produced, and a sintered body was produced in the same manner as in Example 1 except for the above.

### Comparative Example 3

A molded body was produced and a sintered body was produced in the same manner as in Example 1, except that the raw material powder was used as it was instead of a composite powder.

### Comparative Example 4

Instead of an additive solution, only a solvent was added to a raw material powder while the raw material powder was stirred, thereby to obtain the raw material powder in a wet state. Ethanol was used as the solvent. The raw material powder in the wet state was heated and dried at a temperature of 90° C. or less while being stirred to remove the solvent, thereby to obtain the raw material powder in a dry state. A molded body was produced and a sintered body was produced in the same manner as in Example 1, except that the raw material powder was used instead of a composite powder.

The molded bodies and sintered bodies produced in the above examples and comparative examples were evaluated as described below.

### [Evaluation]

### (Rate of Non-Defective Molded Bodies)

In order to evaluate the weighing stability of the powder, the rate of non-defective molded bodies was determined. Specifically, 300 molded bodies were produced using an automatic molding machine, and the masses of the 300 molded bodies were measured. The rate of the number of molded bodies whose masses were within +0.5% of the target mass (good products) among the 300 molded bodies was obtained as the rate of non-defective molded bodies. If the weighing stability of the powder is high, the mass variation among the molded bodies is reduced, and the rate of non-defective molded products increases.

### (Carbon Content of Sintered Body)

The carbon content (ppm by mass) of the sintered body was determined using about 1 g of the sintered body. The measurement device was a carbon/sulfur analyzer (manufactured by Horiba, Ltd.).

### (In-Liquid LC)

The sintered body with the anode wire partially embedded therein was subjected to chemical conversion treatment (anodization). The chemical conversion treatment was performed in a 0.02 mass % phosphoric acid aqueous solution at a chemical conversion voltage of 80 V and a temperature of 60° C. A predetermined voltage of less than 80 V was applied to the sintered body (anode body) having undergone the chemical conversion treatment in the phosphoric acid aqueous solution, and the current value after a lapse of a predetermined time since the start of the voltage application was determined as an in-liquid leakage current (LC).

### (Ratio of Bulk Density D2 of Composite Powder in Terms of Raw Material Powder to Bulk Density D1 of Raw Material Powder)

### (Bulk Density D1 of Raw Material Powder)

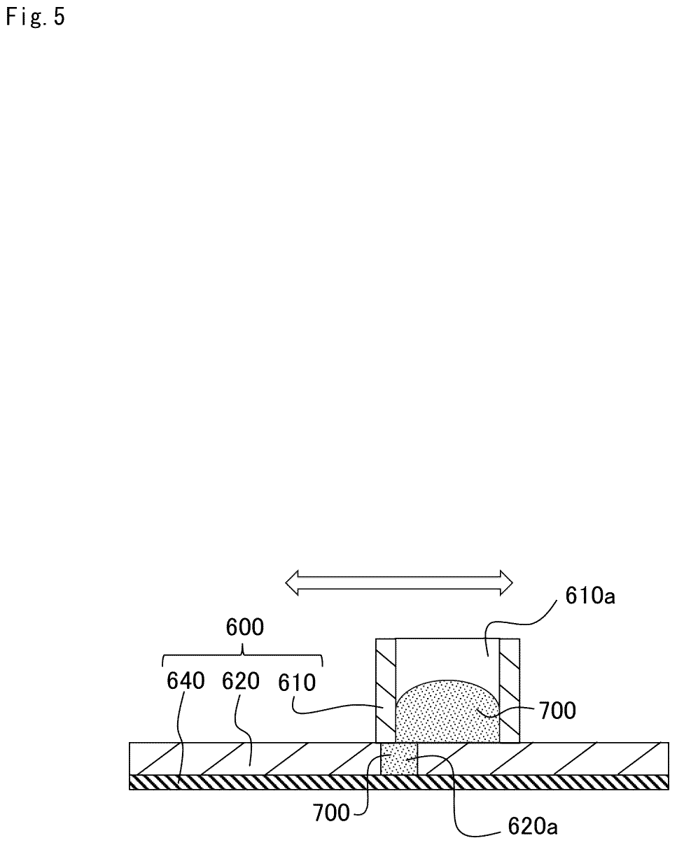

The bulk density D1 of the raw material powder was determined by the following method using a measurement jig set shown in FIG. 5.

A measurement jig set 600 shown in FIG. 5 was prepared. Specifically, a stainless steel hollow cylindrical charging jig 610 (an inner diameter of 20 mm), a stainless steel plate-shaped weighing jig 620 (a thickness of 8 mm) having a weighing hole 620a (a diameter of 8 mm and a depth of 8 mm) with a circular cross section in the center, and a metal plate 640 were prepared. As shown in FIG. 5, the weighing jig 620 was placed on the metal plate 640, and the charging jig 610 was placed on the weighing jig 620. At this time, the charging jig 610 was placed in a position that did not overlap the weighing hole 620a. Five grams of raw material powder 700 were put into a hollow portion 610a of the charging jig 610, and the charging jig 610 was reciprocated once (in the directions of arrows shown in FIG. 5) so as to pass by the weighing hole 620a of the weighing jig 620. In this manner, the powder 700 was charged into the weighing hole 620a. Next, the powder 700 was taken out from the weighing hole 620a and its mass was measured. Such measurement was repeated 10 times. The average value of the 10 measurements was calculated with a mass M1 of the raw material powder charged in the weighing hole 620a. The bulk density D1 of the raw material powder was calculated by dividing the mass M1 by a volume V of the weighing hole 620, that is, by calculating M1/V.

### (Bulk Density D2 of Composite Powder in Terms of Raw Material Powder)

A mass M2 of the composite powder charged in the weighing hole 620a was determined by the same method as above. The mass M2a of the composite powder in terms of the raw material powder was determined by calculating M2/(1+(X/100)). Note that “X” in the formula is the content of the additive in the composite powder (amount (parts by mass) per 100 parts by mass of the raw material powder), and is the amount of the additive (parts by mass) in Table 1.

The obtained mass M2a of the composite powder in terms of the raw material powder was divided by the volume V of the weighing hole 620, that is, M2a/V was calculated to determine the bulk density D2 of the composite powder in terms of the raw material powder.

Using the obtained D1 and D2, D2/D1 was calculated.

### (Coarse/Dense Distribution Index of Sintered Body)

In order to evaluate the density variation of the sintered body, the coarse/dense distribution index of a side surface of the sintered body was obtained as described below.

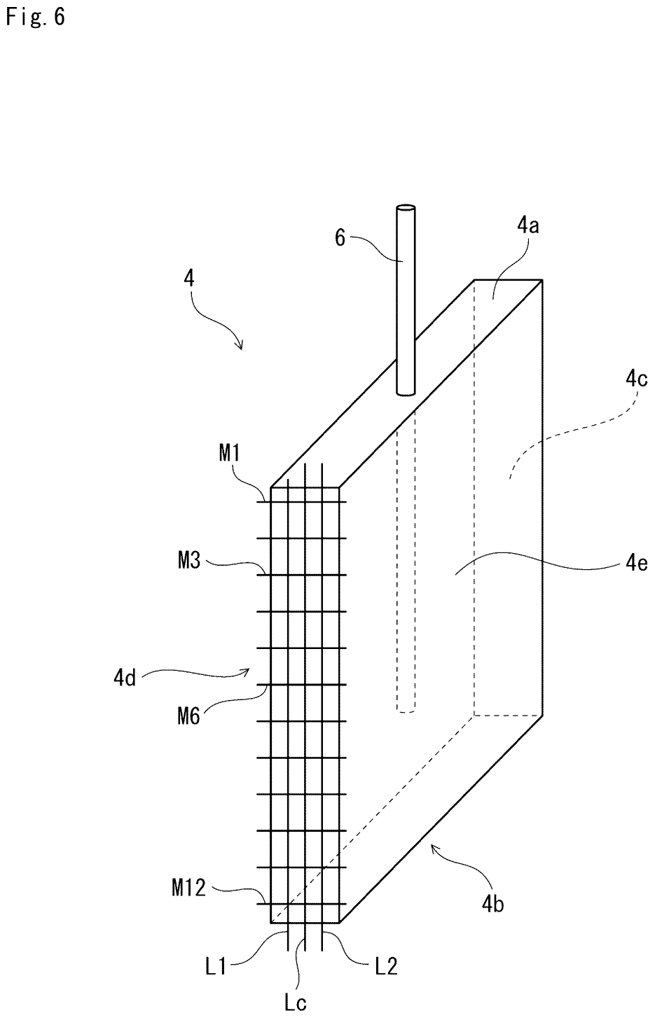

FIG. 6 is a schematic perspective view of a porous body (sintered body) in which a portion of the anode wire is embedded.

A porous body (sintered body) 4 shown in FIG. 6 has a first surface 4a and a second surface 4b, a third surface 4c and a fourth surface 4d, a fifth surface 4e and a sixth surface (not shown) opposite to the fifth surface 4e. The third surface 4c and the fourth surface 4d are narrower than the fifth surface 4e and the sixth surface. A portion of the anode wire 6 is embedded in the porous body 4, and the remaining part of the anode wire 6 extends to the outside from the first surface 4a of the porous body 4.

First, three straight lines were drawn on the fourth surface 4d of the porous body (sintered body) 4 in the longitudinal direction of the anode wire 6. A central straight line Lc was drawn to divide the width perpendicular to the longitudinal direction of the fourth surface 4d into two equal parts. Two straight lines L1 and L2 were drawn 0.25 mm away from the central straight line Lc, sandwiching the central straight line Lc in between. Next, twelve straight lines M1 to M12 were drawn in a direction perpendicular to the longitudinal direction of the anode wire 6. The straight line M1 closest to the first surface 4a was drawn 0.25 mm away from the end of the fourth surface 4d on the first surface 4a side. Similarly, the straight line M12 closest to the second surface 4b was drawn 0.25 mm away from the end of the fourth surface 4d on the second surface 4b side. The remaining ten straight lines were drawn so as to divide the area between the straight lines M1 and M2 into 11 equal parts. The Vickers hardness was measured at 36 intersections between the straight lines Lc, L1, and L2 and the straight lines M1 to M12 (see FIG. 6). The Vickers hardness was measured according to JIS Z 2244. The average value and standard deviation of the measured values at the 36 points were obtained, and the coefficient of variation was calculated by calculating (the standard deviation/the average value).

The coefficients of variation were determined for five sintered bodies, and the average of the five coefficients of variation was calculated and used as the coarse/dense distribution index of the side surface of the sintered body. A low coarse/dense distribution index indicates that the density variation of the sintered body is small.

Table 1 shows the evaluation results. The amounts of additives in Table 1 indicate the amounts per 100 parts by mass of the raw material powder.

TABLE 1

| | | | | | Bulk | | | Carbon | |
|---|---|---|---|---|---|---|---|---|---|
| | | | | | density | | | content | |
| | | | Amount | | ratio of | Ratio of | Coarse/dense | of | In- |
| | | Solvent | of | | composite | non- | distribution | sintered | liquid |
| | Additive | contained | additive | Molded | powder to | defective | index of | body | LC of |
| | contained | in | (parts | body | raw | molded | sintered | (ppm | sintered |
| | additive | additive | by | cleaning | material | bodies | body side | by | body |
| | solution | solution | mass) | step | powder | (%) | surface | mass) | (μA) |
| Example 1 | Coumarin | Ethanol | 0.01 | Absent | 1.04 | 78 | 0.24 | 74 | 18.9 |
| Example 2 | Coumarin | Ethanol | 0.05 | Absent | — | 79 | 0.23 | 121 | 20.9 |
| Example 3 | Coumarin | Ethanol | 0.1 | Absent | 1.02 | 82 | 0.23 | 142 | 21.5 |
| Example 4 | Coumarin | Ethanol | 0.5 | Absent | 0.96 | 90 | 0.22 | 168 | 25.9 |
| Example 5 | Coumarin | Ethanol | 1 | Absent | 0.93 | 98 | 0.21 | 184 | 28.8 |
| Example 6 | Coumarin | Ethanol | 1.5 | Absent | — | 97 | 0.2 | 199 | 29.8 |
| Example 7 | Coumarin | Ethanol | 2 | Absent | — | 97 | 0.2 | 220 | 31.6 |
| Example 8 | Coumarin | Ethanol | 1 | Present | 0.93 | 98 | 0.21 | 50 | 10.4 |
| Example 9 | Vanillin | Ethanol | 0.1 | Absent | 1.02 | 92 | 0.25 | 158 | 17.9 |
| Example 10 | Vanillin | Ethanol | 1 | Absent | 0.97 | 99 | 0.22 | 213 | 18.4 |
| Comparative | Acrylic | Toluene | 1.5 | Absent | 1.05 | 99 | 0.28 | 223 | 42.1 |
| Example 1 | resin | | | | | | | | |
| Comparative | Camphor | Methanol | 1.5 | Absent | — | 45 | — | 48 | 10.4 |
| Example 2 | | | | | | | | | |
| Comparative | None | — | — | Absent | 1 | 55 | 0.29 | 49 | 10.1 |
| Example 3 | | | | | | | | | |
| Comparative | None | Ethanol | 0 | Absent | 1.07 | 48 | 0.35 | — | — |
| Example 4 | | | | | | | | | |

In Examples 1 to 10 in which the aromatic compound A was used as an additive, the rate of non-defective molded bodies was high and the mass variation between the molded bodies was small. In addition, since the density variation within the molded body was small, the coarse/dense distribution index of the side surface of the sintered body was small, and the density variation within the sintered body was small. The carbon content of the sintered body was reduced, and the in-liquid LC was reduced. Since the density variation within the molded body was small, the occurrence of cracks and chips at the corners of the molded body was suppressed. When the additive amount of the aromatic compound A was large, the ratio of the bulk density of the composite powder in terms of the raw material powder to the bulk density of the raw material powder tended to be smaller, and the coarse/dense distribution index of the side surface of the sintered body tended to be smaller (coumarin was used in Examples 1 to 7, and vanillin was used in Examples 9 and 10).

When the additive amount of the aromatic compound A was large, the weighing stability of the powder was further improved and the rate of non-defective molded bodies was further increased. When the additive amount of the aromatic compound A was small, the carbon content of the sintered body was further reduced and the LC in the liquid was further reduced.

When the immersion step and the heating step were performed in combination in the step of removing the aromatic compound A, the carbon content of the sintered body was significantly reduced while the coarse/dense distribution index of the side surface of the sintered body was maintained at a small value, and the in-liquid LC was significantly reduced (Examples 5 and 8), compared to the case where the aromatic compound A was removed by only the heating step.

In Comparative Example 1 in which the additive was an acrylic resin, the carbon content became high, and the in-liquid LC increased. In Comparative Example 2, camphor was added to Ta powder with an average particle size of less than 100 μm, so that the weighing stability was decreased, the rate of non-defective molded products was decreased, and the molding yield was decreased.

In Comparative Example 4, the bulk density of the raw material powder was greater than that of Comparative Example 3. This is presumably because the raw material powder was more likely to aggregate than in Comparative Example 3 due to the influence of ethanol used as a solvent in Comparative Example 4.

Although the present invention has been described in relation to the presently preferred embodiments, such disclosure should not be interpreted as limiting. Various variations and modifications will no doubt become apparent to those skilled in the art to which the present invention pertains upon reading the above disclosure. Therefore, the appended claims should be interpreted to cover all variations and modifications without departing from the true spirit and scope of the present invention.

### INDUSTRIAL APPLICABILITY

The composite powder according to the present disclosure is suitable for use in manufacturing a porous body contained in an anode body of an electrolytic capacitor.

### REFERENCE NUMERALS

1: anode body
2: solid electrolyte layer
3: cathode layer
3a: carbon layer
3b: metal paste layer
4: porous body
5: dielectric layer
6: anode wire
6a: first portion
6b: second portion
8: conductive member
10: capacitor element
11: exterior resin
12: anode lead terminal
13: cathode lead terminal
20: electrolytic capacitor
100: raw material powder
110: mixing container
200: solution of aromatic compound A
300: composite powder
310: molded body
410: leveling slider
420: weighing mold
430: press mold
440: lower mold
450: upper mold
460: space
500: equipment
510: removal furnace of aromatic compound A
520: sintering furnace
530: recovery tank of aromatic compound A
540: heat-retention pipe
550: vacuum pump
600: evaluation jig set
610: charging jig
610a: hollow portion
620: weighing jig
620a: weighing hole
640: metal plate
700: powder

What is claimed is:

1. A composite powder for use in manufacturing a porous body contained in an anode body of an electrolytic capacitor, the composite powder comprising:
a raw material powder containing a valve metal; and
an aromatic compound (excluding naphthalene and a polymer) adhered to a surface of a particle of the raw material powder,
wherein the aromatic compound has a melting point of 35° C. or more and 120° C. or less.

2. The composite powder according to claim 1, wherein the aromatic compound has a boiling point of 400° C. or less.

3. The composite powder according to claim 1, wherein the aromatic compound contains an oxygen atom.

4. The composite powder according to claim 1, wherein the aromatic compound is constituted of only a carbon atom, a hydrogen atom, and an oxygen atom.

5. The composite powder according to claim 1, wherein in the aromatic compound, some of carbon atoms constituting a benzene ring are substituted with oxygen atoms, or an oxygen atom is bonded to at least one of the carbon atoms constituting the benzene ring.

6. The composite powder according to claim 1, wherein the aromatic compound contains at least one selected from the group consisting of coumarin, vanillin, thymol, p-methoxyphenol, phenyl salicylate, benzyl, and 3-phenylpropionic acid.

7. The composite powder according to claim 1,
wherein a solubility of the aromatic compound in 100 g of a solvent at 20° C. is 10 g or more, and
the solvent is ethanol, isopropanol, or butyl acetate.

8. The composite powder according to claim 1, wherein a content of the aromatic compound in the composite powder is 0.01 parts by mass or more and 2 parts by mass or less per 100 parts by mass of the raw material powder.

9. The composite powder according to claim 1, wherein a bulk density of the composite powder in terms of the raw material powder is lower than a bulk density of the raw material powder.

10. The composite powder according to claim 1, wherein the anode body includes the porous body containing the valve metal and a dielectric layer covering a surface of the porous body.

11. A manufacturing method of a composite powder for use in manufacturing a porous body contained in an anode body of an electrolytic capacitor, the manufacturing method comprising the steps of:
preparing a raw material powder containing a valve metal;
preparing an additive solution containing an aromatic compound (excluding naphthalene and a polymer) having a melting point of 35° C. or more and 120° C. or less, and a solvent;
adding the additive solution to the raw material powder while stirring the raw material powder to obtain the raw material powder in a wet state; and
drying the raw material powder in the wet state while stirring to remove the solvent and obtain a composite powder,
wherein the composite powder contains the raw material powder and the aromatic compound adhered to a surface of a particle of the raw material powder.

12. The manufacturing method of a composite powder according to claim 11, wherein the aromatic compound has a boiling point of 400° C. or less.

13. The manufacturing method of a composite powder according to claim 11, wherein the aromatic compound includes at least one selected from the group consisting of coumarin, vanillin, thymol, p-methoxyphenol, phenyl salicylate, benzyl, and 3-phenylpropionic acid.

14. The manufacturing method of a composite powder according to claim 11, wherein a content of the aromatic compound in the composite powder is 0.01 parts by mass or more and 2 parts by mass or less per 100 parts by mass of the raw material powder.

15. The manufacturing method of a composite powder according to claim 11, wherein an additive amount of the additive solution is 5 parts by mass or more and 20 parts by mass or less per 100 parts by mass of the raw material powder.

16. The manufacturing method of a composite powder according to claim 11, wherein the solvent includes at least one selected from the group consisting of ethanol, isopropanol, and butyl acetate.

17. The manufacturing method of a composite powder according to claim 11, wherein the anode body includes the porous body containing the valve metal and a dielectric layer covering a surface of the porous body.

18. The manufacturing method of a composite powder according to claim 11, wherein a solubility of the aromatic compound in 100 g of ethanol, isopropanol, or butyl acetate at 20° C. is 10 g or more.

19. A manufacturing method of an anode body for an electrolytic capacitor, comprising the steps of:
preparing a composite powder including a raw material powder containing a valve metal and an aromatic compound (excluding naphthalene and a polymer) adhered to a surface of a particle of the raw material powder;
charging the composite powder into a predetermined mold and pressure-molding the composite powder to obtain a molded body;
removing the aromatic compound contained in the molded body;
sintering the molded body from which the aromatic compound has been removed to obtain a porous body; and
forming a dielectric layer on a surface of the porous body to obtain an anode body,
wherein the aromatic compound has a melting point of 35° C. or more and 120° C. or less.

20. The manufacturing method of an anode body for an electrolytic capacitor according to claim 19, wherein the aromatic compound has a boiling point of 400° C. or less.

21. The manufacturing method of an anode body for an electrolytic capacitor according to claim 19, wherein the aromatic compound includes at least one selected from the group consisting of coumarin, vanillin, thymol, p-methoxyphenol, phenyl salicylate, benzyl, and 3-phenylpropionic acid.

22. The manufacturing method of an anode body for an electrolytic capacitor according to claim 19, wherein a content of the aromatic compound in the composite powder is 0.01 parts by mass or more and 2 parts by mass or less per 100 parts by mass of the raw material powder.

23. The manufacturing method of an anode body for an electrolytic capacitor according to claim 19, wherein the step of removing the aromatic compound contained in the molded body includes a heating step of heating the molded body to vaporize the aromatic compound.

24. The manufacturing method of an anode body for an electrolytic capacitor according to claim 23,
wherein the step of removing the aromatic compound contained in the molded body includes:
an immersion step of immersing the molded body in an organic solvent to dissolve the aromatic compound in the solvent; and
the heating step to be performed after the immersion step.

25. The manufacturing method of an anode body for an electrolytic capacitor according to claim 24, wherein the organic solvent is ethanol, isopropanol, or butyl acetate.
